(19) United States
(12) Patent Application Publication
(10) Pub. No.: US 2009/0296737 A1
(43) Pub. Date: Dec. 3, 2009

(54) METHOD AND SYSTEM FOR CONNECTING TWO NODES OVER MULTIPLE COMMUNICATION LINKS

(76) Inventor: Ram ARYE, Rishon-Le-Zion (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 12/472,881

(22) Filed: May 27, 2009

Related U.S. Application Data
(60) Provisional application No. 61/058,471, filed on Jun. 3, 2008.
(60) Provisional application No. 61/079,792, filed on Jul. 10, 2008.

(51) Int. Cl. H04L 29/02

(52) U.S. Cl. 370/465; 370/535

(57) ABSTRACT

A communications system to inverse multiplex media communication traffic from a high-speed communication link into a plurality of low-speed communication links, wherein each low-speed link can use a different physical line, having different speeds, and wherein the communication over each link can comply with different communication protocols and can be connected on different networks, and then combined the media communication traffic at the other end. The system may include a transmitting inverse multiplexer and a receiving multiplexer. The transmitting inverse multiplexer can be connected to an egress of one of the nodes as the high-speed communication link. The receiving multiplexer can be connected to ingress of a second node as the other side of the high-speed communication link. The transmitting inverse multiplexer and the receiving multiplexer can communicate over a plurality of communication links. Each communication link can be connected to a different network using a different physical line.

### CROSS-REFERENCE TO RELATED APPLICATIONS

This application is being filed under 35 USC 111 and 37 CFR 1.53(b) and claims the benefit of the filing dates of the U.S. Provisional Application for Patent that was filed on Jun. 3, 2008 and assigned Ser. No. 61/058,471 and the U.S. Provisional Application for Patent that was filed on Jul. 10, 2008 and assigned Ser. No. 61/079,792, both of which are herein incorporated by reference.

### BACKGROUND

The present disclosure generally relates to communication networks, and more particularly, the disclosed embodiments relate to a system and method for combining a plurality of communication links into a virtual link between two nodes.

The rapid evolution of communication networks has created a significant demand for bandwidth consumption—a demand that has been placed on the shoulders of the service providers to meet. A service provider can be a cellular carrier, a Public Switched Telephone Network (PSTN) carrier, data network carrier an access network service provider, an Internet Service Provider (ISP), etc. A common network of a service provider can include a central premises, a plurality of intermediate nodes and a plurality of subscribers. In a common network, one side of the intermediate nodes is connected to the customer equipment and the other side is connected to the central premises either directly or through one or more other intermediate nodes. The network that connects the central premises and the intermediate nodes can be referred to as the infrastructure of the service provider or as the fixed network of the service provider. Typically, changes in the fixed network are quite expensive for a service provider because the intermediate nodes are spread over a wide geographic region (such as the country of operation) and each intermediate node is connected using a wide bandwidth communication link.

An exemplary service provider can be a carrier of wireless communication networks for mobile communications such as but not limited to Global System for Mobile communications (GSM) networks, 3G networks, etc. A common fixed network of a cellular carrier can include a Radio Network Controller (RNC) located in a central premises and a plurality of node base stations (Nb), which are spread over a large geographic region (such as the country of operation), as intermediate nodes.

Henceforth, the description, drawings and claims of the present disclosure may use the terms RNC as a representative term for a central node and Nb as a representative term for an intermediate node. Exemplary mobile terminals (MT) can be a cellular telephone, a PDA with cellular capabilities, or any other computerized device that can generate and/or receive media such as audio, video, data or any combination of those via a communication network such as, but not limited to a cellular network.

Usually an RNC is used as an aggregation point for different types of data transferred to and from a plurality of MTs. The RNC can receive circuit switch telephony traffic as well as packet switched traffic traveling to and from the Internet, for example. Usually, a communication line between a central point and an intermediate node can carry a plurality of communication sessions, each potentially composed of a different type of media, between one or more other intermediate nodes and/or one or more terminals. Different types of networks and protocols can be used over the communication lines. The communication lines can comply with different types of data link layer protocols, such as but not limited to: Time Division Multiplexing Access (TDMA), Asynchronous Transfer Mode (ATM), Ethernet, etc.

A common evolution process starts with adding similar resources in parallel. Later, a technology evolution (changing protocols, new and advance equipments, new technologies, etc.) occurs and creates a breakthrough in the performance. Usually such an evolution requires changes in the fixed network of a service provider. Such changes may include adding new or changing physical lines to respond to the extra bandwidth requirements. In some cases, the new equipment cannot work with the current infrastructure of a service provider. Upgrading the fixed network is expensive and if at all possible, service providers would prefer an alternative solution. Thus there is a need in the art for a communication multiplexer that alleviates the cost and or necessity of upgrading fixed networks as technology continues to grow and migrate. Such a need could be addressed by a system and method that can inverse multiplex a high-speed data stream from one physical link connecting two nodes, into a plurality of physical low-speed communication links that connect the two nodes. Each communication link can have a different bandwidth and can comply with different communication protocols and be carried over different networks.

### SUMMARY

Exemplary embodiments of a communications multiplexer seek to provide a novel apparatus and method for inverse multiplexing media communication traffic from a high-speed communication link into a plurality of low-speed communication links, wherein each low-speed link can use a different physical line, having different speeds, and wherein the communication over each link can comply with different communication protocols and can be connected on different networks. Exemplary one or more low-speed communication links can be connected to an Internet Protocol (IP) network, ATM networks, Ethernet networks, etc. Some of the communication links can be based on physical layer technologies such as, but not limited to, Single pair High-speed Digital Subscriber Line (SHDSL), Symmetric Digital Subscriber Line (SDSL), Asymmetric Digital Subscriber Line (ADSL) and Very high data rate Digital Subscriber Line (VDSL). The physical lines can be a twisted-pair, a bundle of a plurality of twisted-pairs, a point to point wireless link, a fiber optics line, etc.

A physical layer and a data link layer are the two lowest layers of the OSI model. The OSI (Open System Interconnection) is a seven layer communication system. Each layer in the OSI model is a collection of related functions that provide services to the layer above it and receives services from the layer below it. The layers in the OSI model include (1) the Physical Layer in which the information is presented in a bits binary format; (2) the Data link Layer in which the bits from the Physical layer are arranged in logical sequences called frames; (3) the Network Layer which fragments the above frames into packets; (4) the Transport Layer which segments the above packets to segments; (5) the Session Layer; (6) the Presentation Layer and (7) the Application Layer. The Session Layer, the Presentation Layer and the Application Layer is often collectively referred to as the User layer.

One of the described embodiments defines a new type of Transport Layer protocol. The flow control of this new type of Transport Layer protocol enables the allocation of media traffic from one high-speed communication link into two or more low-speed communication links of a service provider. The low-speed communication links can differ from each other in at least one of the communication protocols that are used over each link. For instance, one low-speed communication link can be based on the internet protocol (IP) while the other can be based on ATM or ISDN, etc. The low-speed communication links can be carried over various Physical Layers. For instance, one low-speed communication link can be carried over a microwave link, while the other can be carried over copper or fiber-optic cable, etc.

An exemplary system can comprise two devices: a transmitting inverse multiplexing module (TIMM) and a receiving multiplexing module (RMM). The TIMM can be connected to an egress of one of the nodes as the high-speed communication link. The RMM can be connected to ingress of a second node as the other side of the high-speed communication link. The transmitting and the receiving modules can communicate over a plurality of communication links. Each communication link can be connected to a different network using a different physical line. In an alternate exemplary embodiment, two combined inverse multiplexing modules (CIMM) can be used, one in located at each side of the high-speed communication link. Each CIMM can include elements of a TIMM and elements of a RMM. Yet in an alternate embodiment, an exemplary TIMM and/or RMM can be embedded within an intermediate node.

The exemplary TIMM can be adapted to receive a stream of groups of bits. In one embodiment, the stream of group of bits can be a stream of bits that comply with the Physical Layer protocol used over the high-speed connection. In an alternate embodiment, the stream of groups of bits can be a stream of ATM cells carried over the high-speed communication link. Yet in another embodiment, the stream of groups of bits can be a stream of packets carried over the high-speed communication link, etc. The received stream of groups of bits can be handled by the TIMM as a stream of groups of bits of a “network independent message interchange”. The sequential stream of groups of bits which is received as the data of the high-speed communication link is converted into a new type of transport layer by an exemplary transmitting “Inverse Multiplexing Transport Protocol (IMTP)” module (TIMTPM). An exemplary new type of transport layer protocol is disclosed below. The output from the TIMTPM can be inverse multiplexed by a switch to a plurality of FIFOs (first in first out) buffers. In an exemplary embodiment, flow control criterion can be used for controlling the switch. Each FIFO can be associated with a low-speed output interface module (LSOIFM).

Each LSOIFM is connected to one of the low-speed communication links. Each LSOIFM can be adapted to (a) receive a plurality of data segments which were processed according to the IMTP, and (b) process the received IMTP segments according to: the Network Layer protocol, Data link Layer protocol and the Physical Layer protocol that are used by the low-speed communication link that is associated with the LSOIFM. The processed data is transmitted over the associated low-speed communication link toward the receiving module.

Inverse multiplexing decisions made by an exemplary TIMTPM can be based on the obligations or contractual requirements of the service provider to its subscribers. For instance, the service provider's obligations or requirements may include defining or establishing parameters, such as performance parameters, that can establish minimum criteria required to ensure a particular level of experience by the user. One parameter can define the maximum latency that is contributed by the operator (Lmax). Another parameter can define the maximum jitter between consecutive segments (Jmax). Yet another parameter can establish the percentage of dropped calls or disconnections, etc. In order to comply with the obligations of the service provider, an exemplary TIMTPM can consecutively calculate, per each low-speed communication link, the delay time (Tdn) that a next IMPT segment of data will stay in its associated FIFO before being transferred to the FIFO. The ‘n’ in Tdn can reflect the serial number of the low-speed path ‘n’, wherein the low-speed path can include the FIFO, its associated LSOIFM and the low-speed communication link. The Tdn value can be used as an indication for the current load over the low-speed communication link number ‘n’. A jitter can be defined as unwanted variation between two consecutive intervals of time between successive segments of data that are currently transferred.

An exemplary inverse multiplexing process can route a plurality of consecutive IMTP data segments toward one of the FIFOs (FIFO ‘n’, for example), until Tdn becomes equal or greater than a portion of Lmax minus Jmax, [Tdn>(Lmax−Jmax)]*(a factor), wherein the factor is smaller than one. Exemplary values of the factor can be 0.95; 0.90; 0.8; etc. The value of the portion of the difference of Lmax minus Jmax can be referred as Tdmax. At this point the IMPTM can search for a FIFO that its current Td is smaller than Jmax. For example, the Tdm of FIFO ‘m’ is smaller than Jmax. Then, the next IMTP data segments are routed toward FIFOm to be transmitted over its associated low-speed communication line ‘m’, while FIFOn is drained by its associated LSOIFM, and so on. The above exemplary embodiment uses the Lmax and Jmax as flow control criteria. Other embodiments may use other flow control criteria.

An exemplary TIMTPM can add control information to each IMTP data segment, such as a sequence number, for example. For each block of consecutive IMTP data segments that is routed toward one of the FIFOs, a CRC data segment can be calculated and added to the end of the blocks. Each block can have a different number of IMTP data segments depending on the current situation of the low-speed path via which the block is transmitted. One or more control IMTP segments can be added to the beginning and the end of each block. An exemplary control IMTP segment at the beginning of a block of segments can point the low-speed path that carried the previous transmitted block of IMTP data segments. Another one or more control IMTP segments can be added to the end of the current block of IMTP segments. Those control segments can reflect the number of segments that were included in the current block and the low-speed communication path that will carry the next block of IMTP data segments, for example. In an exemplary embodiment, a block is considered as the group of IMTP segments sent over a low-speed communication link and bounded by Previous-Path or First-Path IMTP control segment to Next-Path IMTP control segment.

On the other end of the plurality of low-speed communication links, a mating RMM may receive a plurality of streams of data. Each stream can be received over a low-speed communication link that is associated with a low-speed input interfacing module (LSIIFM). The mating RMM may process the plurality of streams and multiplex them into a single stream of IMTP data segments. The single stream of IMTP data segments can be further processed according to the IMTP and be rearranged to create a stream of groups of bits that complies with or is compatible with the groups of bits carried over the high-speed communication link and that are handled by the mating TIMM. In one embodiment, the stream of groups of bits can be a stream of bits that comply with the Physical Layer protocol used over the high-speed connection. In an alternate embodiment, the stream of groups of bits can be a stream of ATM cells carried over the high-speed communication link. Yet in another embodiment, the stream of groups of bits can be a stream of IP packets carried over the high-speed communication link, etc. The stream of groups of bits is processed according to the relevant protocol of the high-speed communication link and can be sent over the high-speed communication link toward the second intermediate node.

An exemplary LSIIFM can process the received data according to the protocols used by the first three layers of the associated low-speed communication link (the Physical Layer, the Data link Layer and the Network Layer, for example). The output of each LSIIFM, which can be in a format of IMTP data segments, can be stored in a buffer. The output of the buffer is processed according to the IMTP by a receiving IMTP module (RMTPM). The IMTP data segments are organized according to their sequential number and are grouped into blocks of IMTP data segments. Each block can start with a control IMTP segment that indicates a communication path on which the previous block of IMTP data segments was received. Each block can be terminated with several control IMTP segments. For instance, one can point to the next communication path in which the next block of IMTP segments would be sent. Other control IMTP segments can include the number of IMTP data segments that were sent in the current block (the block size). Another control IMTP segment can be a CRC.

An exemplary RMTPM can verify that the number of the received IMTP data segments in the block matches the number of segments that were sent. If not, an error indication can be sent to an administrator of the service provider. The error indication can point the low-speed communication link on which the error happened. A CRC check can be executed on the received block. If it happens that a mistake that cannot be corrected is disclosed, an error indication can be sent. The CRC segment and the control segment that includes the number of segments that were sent can be removed and the received block of IMTP segments can be stored in a FIFO. The control IMTP segment with an indication on the communication path that carried the previous block is the first to be stored in the FIFO, then the IMTP data segments according to their sequential number and finally the control IMTP segment that indicated the communication path the would carry the next block.

The plurality of FIFOs, one per each receiving communication path, is connected to a MUX module. During the initiation of the mating RMM, an exemplary MUX module can be adapted to scan the group of FIFOs, looking for a ‘Starting IMTP control segment”. The FIFO that has the “Starting IMTP control segment” stores the first block of IMTP data segments that was sent. The MUX model starts draining the FIFO, removing the control information that was added as part of the IMTP and creates a stream of group of bits that are transferred toward the high-speed output interface. When the NUX module identifies a control IMTP segment that points the next communication path (a next FIFO), then the first segment from the next FIFO is fetched. This segment is checked to verify that it is a control segment that points to the previous path. If both segments comply, then the MUX module can proceed and retrieving the data from the next path. If not, an error indication can be sent. The stream of group of bits at the output of the MUX module is processed according to the relevant protocol of the high-speed communication link and sent over the high-speed communication link toward the second intermediate node.

Some exemplary embodiments may process the error mistakes and may determine whether to cancel one of the low-speed communication links that is creating or causing the problem.

The foregoing summary is not intended to summarize each potential embodiment or every aspect of the present disclosure, and other features and advantages of the present disclosure will become apparent upon reading the following detailed description of the embodiments with the accompanying drawings and appended claims.

Furthermore, although specific exemplary embodiments are described in detail to illustrate the inventive concepts to a person skilled in the art, such embodiments can be modified to various modifications and alternative forms. Accordingly, the figures and written description are not intended to limit the scope of the inventive concepts in any manner.

### BRIEF DESCRIPTION OF THE SEVERAL VIEWS OF THE DRAWING

Exemplary embodiments of the present invention will be understood and appreciated more fully from the following detailed description, taken in conjunction with the drawings in which:

FIG. 1 is a simplified block diagram illustration of an exemplary portion of a communication network in which an exemplary embodiment of the present invention can be used;

FIG. 2 schematically illustrates a simplified block diagram with relevant elements of an exemplary transmitter inverse multiplexing module (TIMM) that operates according to certain exemplary techniques of the present disclosure;

FIG. 3 schematically illustrates a simplified block diagram with relevant elements of an exemplary receiver inverse multiplexing module (RMM) that operates according to certain exemplary techniques of the present disclosure

FIG. 4A and FIG. 4B schematically illustrates a flowchart showing relevant processes of an exemplary embodiment of a method for implementing inverse multiplexing transport protocol (IMTP) in the transmitter side.

FIG. 5A and FIG. 5B schematically illustrates a flowchart showing relevant processes of an exemplary embodiment of a method for implementing inverse multiplexing transport protocol (IMTP) in the receiver side

FIG. 6 schematically illustrates a flowchart showing relevant processes of an exemplary embodiment of a method for multiplexing a plurality of IMTP streams.

FIG. 7 schematically illustrates a simplified block diagram with relevant elements of a hardware/system environment suitable for various embodiments of the present disclosure or various components of the embodiments of the disclosure.

### DETAILED DESCRIPTION OF THE INVENTION

Turning now to the figures in which like numerals represent like elements throughout the several views, exemplary embodiments of solutions are presented. For convenience, only some elements of the same group may be labeled with numerals. The purpose of the drawings is to describe exemplary embodiments and is not for production purpose. Therefore features shown in the figures were chosen only for convenience and clarity of presentation.

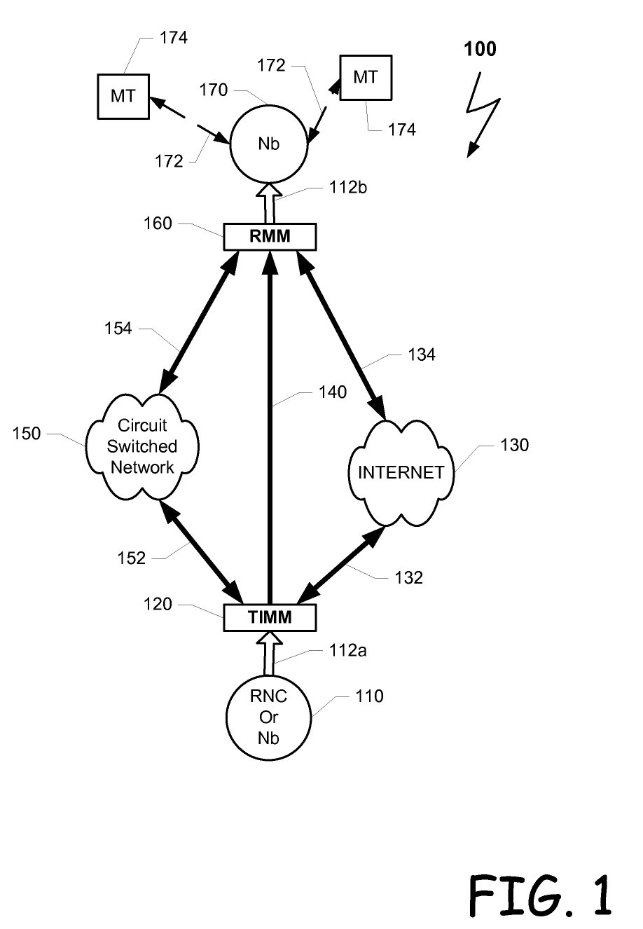

FIG. 1 depicts a block diagram with relevant elements of an exemplary communication system 100 that is a suitable environment for implementing exemplary embodiments. Communication system 100 may comprise a plurality of high-speed intermediate nodes, such as but not limited to, Node Base Station (Nb) 170 and a Radio Network Controller (RNC or Nb) 110, for a cellular service provider. Exemplary other service providers can be such as but not limited to, a n Internet service provider (ISP), a public switched telephone network (PSTN) carrier, a data network carrier, an access network service provider, etc. Each Nb 170 is connected to a plurality of Mobile Terminals (MT) 174 through wireless links 172.

In the example of FIG. 1, the communication from the RNC 110 toward the Nb 170 is carried over, a high-speed link 112a to a Transmitter Inverse Multiplexing Module (TIMM) 120 that inverse multiplexes the high-speed data into different types of low-speed communication links and networks that already exist. The TIMM 120 is shown as being communicatively coupled to the RNC 110 which may include a variety of arrangements. A few non-limiting examples of being communicatively coupled include being hard-wired, wireless, optical, bus, embedded within the RNC 110, or connected through one or more intervening devices or links as well as a combination of any of these listed techniques as well as other non-listed techniques, The exemplary low-speed communication links can be links such as, but not limited to: a Circuit Switch Network 150 (PSTN, ISDN, etc.) links 154 and 152, the Internet 130 links 134 and 132, a point to point Physical link 140, for example. Each of the physical links can be implemented in many different forms such as Wireless links, twisted pairs links, Fiber Optic links, etc. The other side of the low-speed communication link is multiplexed by a Receiving multiplexing module (RMM) 160, which is communicatively coupled to the Nb 170, into a high-speed communication link 112b that is connected on the other side to Nb 170. The number of the low-speed communication links and types can be any number. In FIG. 1 for illustration purposes only, three different low-speed communication links are illustrated.

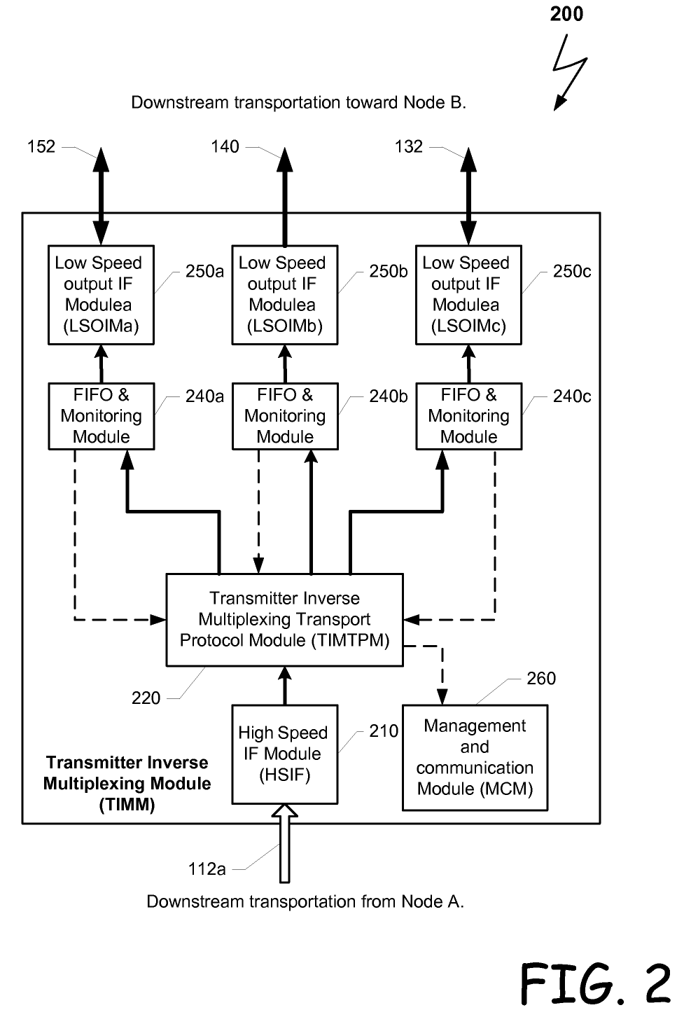

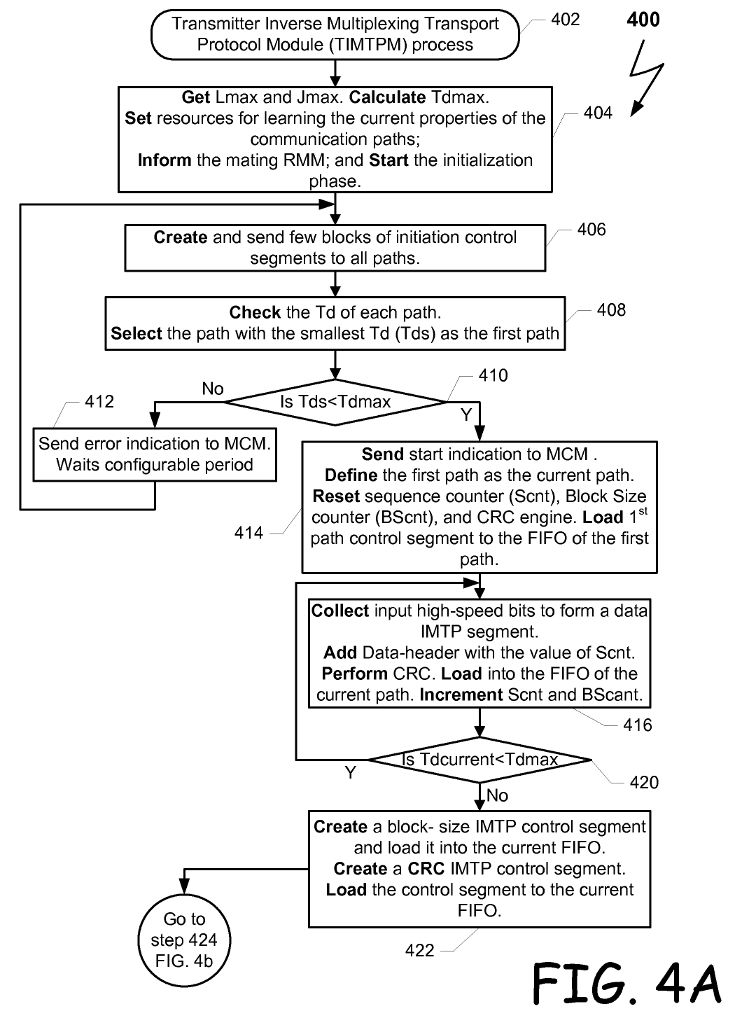

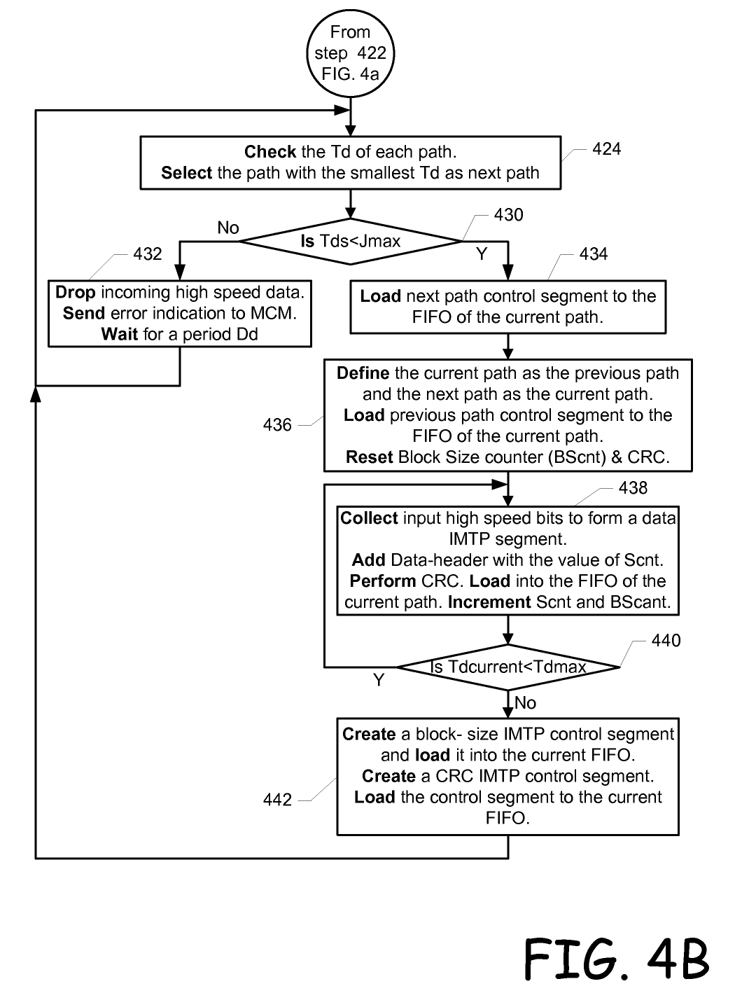

An exemplary TIMM 120 can be capable of receiving high-speed data from communication link 112a and inverse multiplex the data into two or more different low-speed links (152, 140, and 132). The inverse multiplexing decisions are controlled by a flow control mechanism that keeps true to the obligation of the service provider. Obligations, such as but not limited to, the maximum latency (Lmax) and the maximum jitter (Jmax) that the service provider is obligated to provide to its subscribers. More information on the operation of the TIMM 120 is disclosed below in conjunction with FIGS. 2, 4A and 4B.

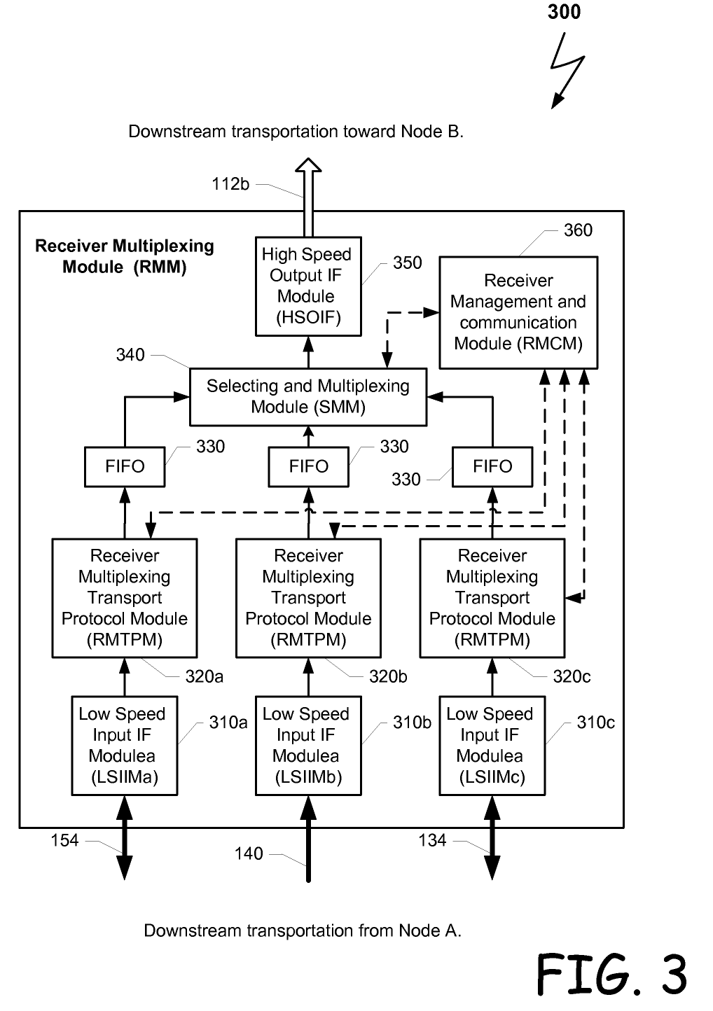

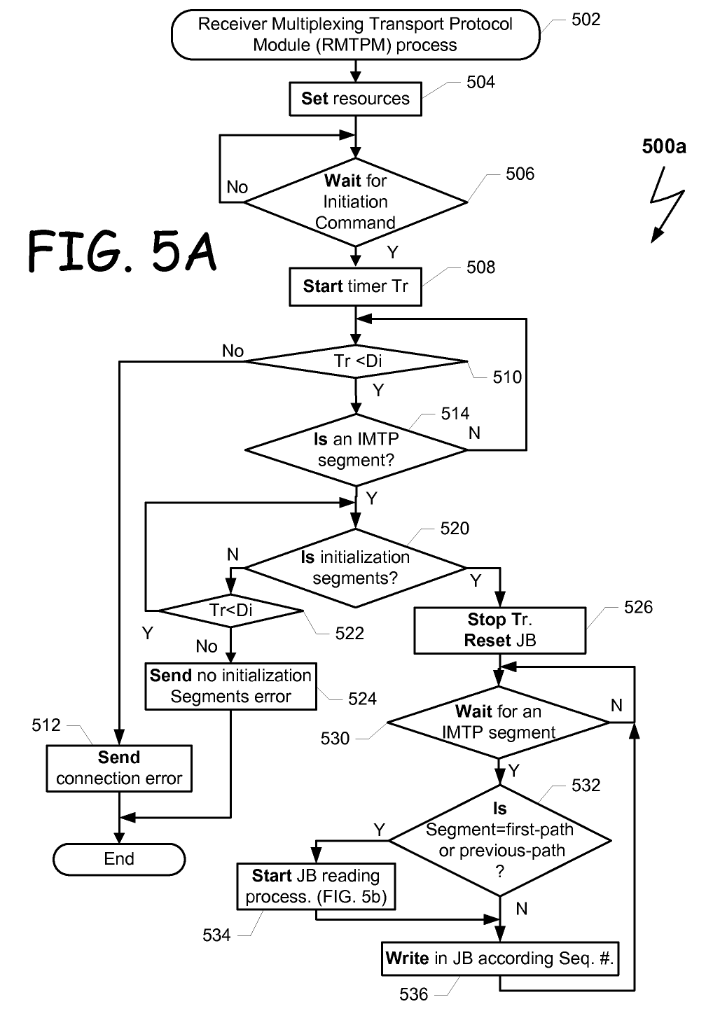

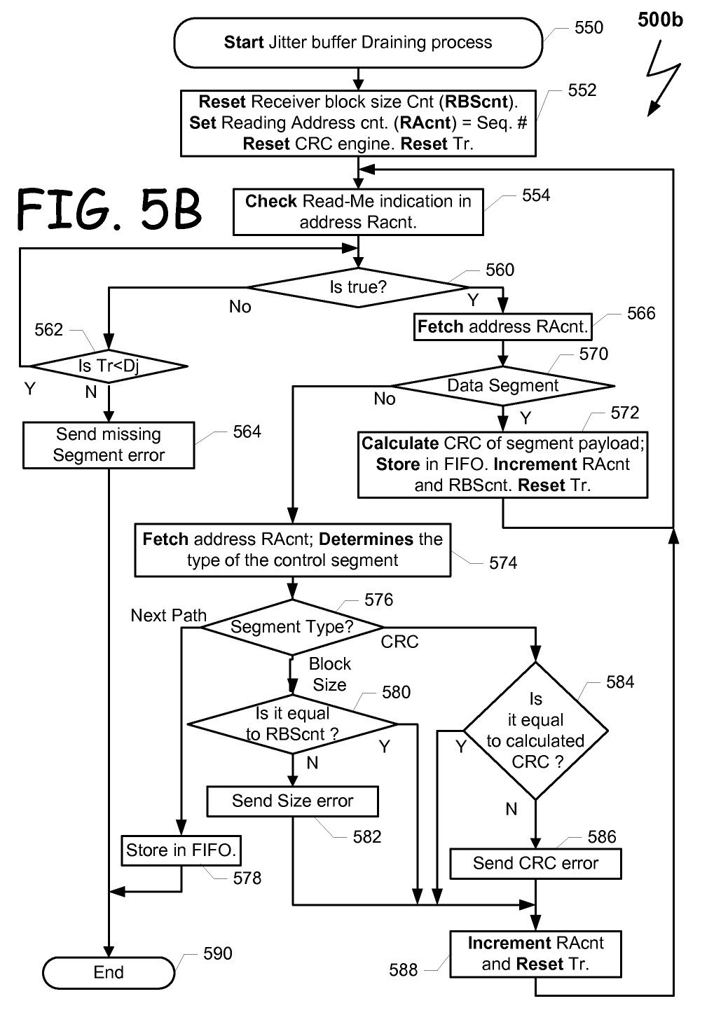

An exemplary RMM 160 is capable of receiving data from the different low-speed links (154, 140, and 134) and multiplex the data into a single data stream that is transmitted over high-speed link 112b toward Nb 170. In addition the RMM 160 is capable of detecting errors and informing the TIMM 120 about the errors. More information on the operation of the RMM 160 is disclosed below in conjunction with FIGS. 3, 5A and 5B.

For a bi-directional high-speed communication link between the two nodes, an exemplary embodiment can use an RMM and a TIMM in association with each one of the nodes (Nb 170 and RNC 110) instead of just a TIMM 120 or just an RMM 160. Another exemplary embodiment can use one module that combines elements of a TIMM and an RMM. Such a combined module can be referred to as a CIMM. A CIMM can be installed in association with each node. Yet in an alternate embodiment of the present invention an exemplary TIMM 120 and/or RMM 160 can be embedded within an intermediate node 110 and 170, respectively. In such embodiment high-speed communication link 112a-b can be eliminated.

FIG. 2 is a block diagram with relevant elements of an exemplary implementation of Transmitter Inverse Multiplexing Module TIMM 200. A high-speed Interface module HSIF 210 is illustrated at the ingress of the TIMM 200 and operates to receive data from an intermediate node, RNC 110 (FIG. 1) for example, via high-speed communication link 112a. The HSIF 210 processes the received signal according to the Physical Layer protocol of the high-speed communication link 112a (a wireless link, twisted pair, fiber optic, etc.) and rearranges the received signal into a stream of groups of bits. The stream of groups of bits is transferred to a Transmitter Inverse Multiplexing Transport Protocol Module (TIMTPM) 220. In this exemplary embodiment, the stream of groups of bits that is handled by TIMTPM 220 is a stream of bits that comply with the Physical Layer protocol used over the high-speed connection 112a.

In another embodiment, the Inverse Multiplexing Transport Protocol may handle streams of groups of ATM cells carried over the high-speed communication link 112a. In such embodiments, an exemplary HSIF can be adapted to also process the data link layer according to ATM protocols. Yet in another embodiment, the stream of groups of bits can be a stream of IP packets carried over the high-speed communication link 112a. In such embodiment, an exemplary HSIF can be adapted to process also the network layer according to internet protocols, etc.

The TIMTPM 220 receives the stream of bits from HSIF 210 and rearranges them according to a new “Inverse Multiplexing Transport Protocol (IMTP)”. An exemplary TIMTPM 220 can divide the stream of bits into IMTP segments and adds a header to each segment. The header, for example can include an indication on the type of the segment, whether the segment is a control segment or data segment. If the segment is a control segment, the header may also include information on the previous path, sequence number of each segment, number of segments, CRC, next path, etc., depending on the type of the control segment. The sequence number and the CRC can be calculated by TIMTPM 220. An exemplary CRC algorithm can create a payload in which each bit is the sum of equivalent bits of the payloads that were sent from the last calculated CRC. If the IMTP segment is a data segment, it will include in addition to the data, a sequence number that is associated to the segment.

In other embodiments, in which an exemplary TIMTPM gets streams of groups of bits from the relevant HSIF, wherein each group comprises a plurality of bits, the TIMTPM can be adapted to process the stream the groups of bits into IMTP segments. Each IMTP segment can include an integer number of groups of bits. An integer number of ATM cells, for example. Or a portion of a group of bits, a portion of IP packet, for example.

The TIMTPM 220 is also responsible for the flow control over a low-speed communication path that will carry the data toward the RMM 160 (FIG. 1). An exemplary flow technique can calculate a current time delay Td (latency) of each one of its output paths. The delay time can be used as an indication for the current load over the associated low-speed communication link. The service provider obligations to its subscribers and the Td of each path can be used by the TIMTPM 220 for determining how to inverses multiplex the data and through which one of the paths a next one or more IMTP segments will be transferred. The service provider's obligations to its subscribers can be the maximum Latency (Lmax) and maximum Jitter (Jmax) for the data that is transferred over its network.

An exemplary IMTP data segment can include one byte of header and a few bytes of payload, one to over a hundred bytes, for example. The payload is required to be small enough in order to meet the Lmax requirements, on one hand. On the other hand, the payload needs to be long enough to reduce the overhead between the payload and header.

An exemplary header can be implemented such that the first three bits, of the header's byte, define the type of the IMTP segment: Data; Initialization; First path; Previous path; Next path; Block size; CRC; etc. The last five bits of the header's byte can be the value of a sequential counter. The number of bytes of the payload of a control IMTP segment can differ for each type of control segment, for example, one byte for the Previous path control IMTP segment or Next path control IMTP segment; payload of the Initialization control IMTP segment can be zero for example. The length of the data IMTP segment can be a fixed size, a fix number of bytes (padding bits can be added if needed).

The output of the TIMTPM 220 can be connected to two or more paths. Each path is associated with a FIFO and Monitoring Module 240a-c and a low-speed output interface module (LSOIM) 250a-c respectively. It will be appreciated by those skilled in the art that depending upon its configuration and the needs, any number other than three paths can also be included in TIMM 200. However, for purposes of simplicity of understanding, three paths are shown.

An exemplary flow control and inverse multiplexing method that can be implemented by TIMTPM 220 can include two phases, an initialization phase and ongoing phase. During the initialization phase TIMTPM 220 determines which of the paths will be the first one to carry data toward RMM 160 (FIG. 1). TIMTPM 220 can measure the time delay (Td) in each path by transmitting in parallel initialization segments to the three FIFO and Monitoring Modules 240a-c. Indication from the FIFO and Monitoring Module 240a-c regarding the size of the memory in use in the FIFO 240a-c and the draining rate, the rate in which the segments are transmitted out of the FIFO and Monitoring Module 240a-c (draining rate). These indications are used by the TIMTPM 220 for calculating the current Td of the path (size of memory in use divided by the draining rate). The TIMTPM 220 can choose to transmit through the path with the shortest Td. If, for example, the time delay of this path is longer than the allowed Lmax minus the Jmax, the TIMTPM 220 informs the Management and Communication Module 260 that it cannot start the ongoing phase. In addition an exemplary TIMTPM 220 may start dropping IMTP data segments.

Once the TIMTPM 220 determines that a first path is available, then the ongoing phase begins. The TIMTPM 220 can create and send a first path IMTP control segment toward the FIFO and monitoring module 240a-c of the first path. TIMTPM 220 starts sending a chain of IMTP data segments toward the first path by dividing the data into payloads of data-segment, incrementing the sequential counter and adding an appropriated data header including the sequential number to each payload.

As a result, the volume used in the FIFO and Monitoring Module 240 of the first path is increased thus the Td of the first path increases. Once the current Td of the path is larger than Lmax minus Jmax (Tdmax), the TIMTPM 220 searches for an alternative path, a path with a current Td smaller than Jmax.

Once an alternative path has been chosen as the next path, TIMTPM 220 starts terminating the transmission of IMTP data segments block by creating and sending few control IMTP segments such as Block Size segment with the number of data segments in the block; a CRC segment with the calculated CRC; and the Next path segment with information on the next path. At this point the current path can be referred to as a previous path. Then, TIMTPM 220 can start transmitting a new block of data segments through the next path, which will now be referred to as the current path. The new block can start by sending a Previous path IMTP segment with the information on the previous path and the CRC processor and the block size counter are reset. The TIMTPM 220 starts sending a chain of IMTP data segments toward the new current path, incrementing the sequential counter, updating the CRC value and adding an appropriate data header including the sequential number to each payload. The sequential counter is not reset when changing paths, rather it is reset in the initialization phase.

As a result the current path's Td starts to increase with each IMTP data segment sent through it, while the Td of the other paths decreases. Once the Td of the current path reaches the value of Tdmax, the TIMTPM 220 starts the procedure of searching and changing to an alternative path as disclosed above, and so on and so forth.

Exemplary FIFO and Monitoring Modules 240a-c can include a FIFO (first in first out) memory device that can be loaded and drained by different clocks and speeds. Each module includes a monitoring unit that measures the draining rate. An exemplary unit can count the number of bytes that are retrieved from the FIFO in a certain unit of time. In addition, the monitoring unit can measure the current used volume of the FIFO. Indication from the FIFO and Monitoring Module 240a-c regarding the size of the memory in use and the draining rate are transmitted toward TIMTPM 220.

In an alternate embodiment, an exemplary FIFO and Monitoring Module 240a-c may use other methods for monitoring the load over its associated low-speed path. An exemplary monitoring module may receive a dropping indication from its mating RMM 160. The dropping indication can be used to prompt the TIMTPM 220 to switch to another low-speed path.

Each low-speed Interface Module (LSOIM) 250a-c is a module or component that converts the IMTP segments to Network Layer, Data Link Layer and Physical Layer according to its associated communication links 152, 140, and 132 (respectively).

Another exemplary embodiment of the TIMM 200 can be embedded in an intermediate Node (such as Nb 170 and\or RNC or Nb 110). In such an embodiment, the high-speed data bit stream of the node is directly entered into the TIMTPM 220 and the HSIF 210 interfaces and converts the signals from the Physical Layer format used over a backbone of the intermediate node to bits stream. In such an embodiment, the high-speed communication link 112a is eliminated.

In another exemplary embodiment, if the value of Td of two or more paths is smaller than Jmax, the Management and Communication Module 260 can force the TIMTPM 220 to select a certain path even if another path has a shorter Td, the decision can be cost oriented, reliability based, or the like.

FIG. 3 is an exemplary embodiment of a Receiver Multiplexing Module RMM 300 that is acting as a mate of the TIMM 200. The inputs to the RMM 300 are the low-speed data communication links 154, 140, and 134. Each one of the low-speed communication links enters a Low-speed Input Interface Module LSIIM 310a-c which is a module that rearranges the low-speed data according to the appropriate Physical Layer protocol, Data Link Layer protocol and Network Layer protocol of the relevant low-speed data communication link to segments of IMTP (inverse multiplex transport protocol). At each path, the IMTP segments are forward toward a relevant Receiver Multiplexing Transport Protocol Module (RMTPM) 320a-c.

The RMTPM 320a-c receives blocks of Inverse Multiplexing Transport Layer segments. For each segment, the RMTPM 320a-c determines the type of the IMTP segment. Data IMTP segments are sorted according to their sequence number and are then stored in a jitter buffer; the CRC value is updated; and a receiving block size counter is incremented by one. In parallel, segments from the jitter buffer can be transferred to a FIFO 330 in the following order: (1) first a First path segment or a Previous path segment (depends if it's the initiation or on-going phase); (2) next, after removing their headers, the data segments are forward from the jitter buffer according to their sequence number.

Upon identifying the control segment “Block size” and the control segment “CRC” their values are compared to the calculated received CRC and block size counter. When RMTPM 320a-c notices a CRC error or the actual number of received segments is different from the number specified in the “block size” control segment, then RMTPM 320a-c notifies the Receiver Management and Communication Module RMCM 360. When the Next-path control segment is received, indicating the end of the block, the next-path segment is transferred to the FIFO 330. In some embodiments, the block size can be limited to a certain number of segments. Therefore, at the mating TIMM 200, when a block size reaches the limit, the block can be terminated and the next path can point to the same path.

The output of each FIFO 330 is connected to a Selecting and Multiplexing Module (SMM) 340. In the initiation phase, an exemplary SMM 340 can scan all FIFOs 330 looking for the first-path segment. Once the first-path segment is found, the SMM 340 starts draining the FIFO storing the first-path segment and rearranges each IMTP segment into bits in an orderly manner. These bits are transferred to a High-speed Output Interface Module (HSOIF) 350. In this exemplary embodiment SMM 340 delivers a stream of bits that comply with the physical layer protocol used over the high-speed connection 112a.

In another embodiment, the SMM may deliver a stream of groups of bits such as ATM cells. In such an embodiment, an exemplary HSOIF can be adapted to also process the Data Link Layer according to ATM protocols. Yet in another embodiment, the stream of groups of bits can be a stream of IP packets carried over the high-speed communication link 112a. In such an embodiment, an exemplary HSIF can be adapted to process also the network layer according to IP, etc.

This procedure continues until the SMM 340 encounters the next-path control segment. The next-path control segment is parsed by the SMM 340 for decoding which is the next FIFO to be drained. Then the SMM 340 starts drawing the segments from the specified FIFO according to the Next-path segment. For the first segment received in next FIFO, the control segment is examined to identify the Previous-path. The SMM 340 can verify that the value of the previous-path segment matches the FIFO previously used. If not, the SMM 340 informs the RMCM 360. If the value matches, then the SMM 340 starts drawing data segments from the next FIFO, dividing each segment into bits in an orderly manner and transferring said bits to the HSOIF 350 and so on and so forth.

The HSOIF 350 receives a stream of bits and converts them to a stream of high-speed signals (RF, Analog or optic, for example) depending on the physical layer of the high-speed communication link 112b. In another exemplary embodiment, the RMM 300 is embedded in the intermediate node (Nb 170, FIG. 1, for example). In such embodiments, the HSOIF 350 is connected directly to the backbone of the node without the need for the high-speed communication link 112b.

The MCM 260 (FIG. 2) and the RMCM 360 (FIG. 3) are the management and communication modules of TIMM 200 and RMM 300, respectively. During the Initialization Phase, these management modules can allocate and reset all the resources and modules inside RMM 300TIMM 200 and introduce the internal modules to each other. In addition a communication link between TIMM 200 and RMM 300 and the administrator of the service provider can be established by these management modules, etc. The communication link between RMCM 360 and MCM 260 can be through one of the low-speed communication links 132, 140, 152 or via other communication link.

During the ongoing phase, the management and communication modules MCM 260 and RMCM 360 are responsible to exchange information such as errors detected by one of them. Exemplary errors can be missing segments, CRC errors, dropping indication, synchronization problems detected, etc. In addition, they may receive requests and new demands or changes in the demands of a service provider. Exemplary changes can be a demand to abandon a certain low-speed communication link, a request to start an initialization phase or restart an initialization phase, giving precedence to certain links (for economic reasons for example), information on changes in the hardware or software or firmware in the nodes or in one of the layers protocols or in TIMM 200 or RMM 300, changes in the maximum Jitter and maximum latency, etc. The management and communication modules can inform the service provider or its administrators on the different errors and the actions that were made to overcome the error, for example. More information on the operation of the RMM 300 is disclosed below in conjunction with FIGS. 5A and 5B.

FIG. 4A and FIG. 4B present a flowchart diagram illustrating relevant processes of an exemplary method 400. Method 400 can be executed by an exemplary Transmitter Inverse Multiplexing Transport Protocol Module TIMTPM 220 (FIG. 2). Method 400 can be used for rearranging the sequential stream of bits, which is received as data of the Physical Layer of the high-speed communication link from HSIF 210 (FIG. 2) module, into the IMTP transport layer (IMTP segments). Method 400 can be used also for switching the IMTP segments from TIMTPM 220 output via a switch to a plurality of FIFOs buffers. Each FIFO can be associated with a low-speed output interface module LSOIFM 250a-c (FIG. 2).

An Exemplary method 400 may be initiated by MCM 260 (FIG. 2) upon power on, for example. During initiation 402 TIMTPM 220 can be introduced to its input HSIF 210 (FIG. 2) and to its output FIFOs 240a-c. Resources, which are relevant to the operation of TIMTPM 220, can be allocated and reset. Resources such as counters, clock, timer; memory, etc. TIMTPM 220 is updated with different parameters 404 such as, but not limited to, the maximum latency that is required by the operator (Lmax), the maximum jitter between consecutive segments (Jmax), etc. Accordingly, Tdmax is calculated as a fraction of Lmax minus Jmax, Tdmax=(Lmax−Jmax)*factor, while the factor is smaller than one. TIMTPM 220 receives different information on the current properties of the communication paths such as, but not limited to, maximum rate, bandwidth, addressing and so on. TIMTPM 220 informs its mating RMM 160 (FIG. 1) that it starts the initialization phase.

The initialization phase begins by creating and sending 406 few IMTP Initiation-Control segments toward all the low-speed paths of TIMTPM 220 in parallel. The IMTP Initiation-Control segments can include the appropriate header followed by a stream of ‘1’, for example. TIMTPM 220 transfers theses IMTP Initiation-Control segments at the high-speed rate of its input high-speed link 112a (FIG. 2) to each one of its outputs low-speed path. Then TIMTPM 220 calculates the time delay, Td, of each path 408 by receiving, from the FIFO and Monitoring module 240a-c (FIG. 2), the used volume in the FIFO divided by the draining rate of the FIFO. Method 400 selects the path with the smallest Td, referred to as Tds, to be the first path to be used.

Next, a decision is made 410 as to whether the Tds is smaller than the Tdmax. If not, TIMTPM 220 may start dropping high-speed input data bits and an error indication 412 can be sent to the MCM 260 (FIG. 2). Method 400 may wait for few milliseconds, for example, before returning to step 406. If Td is smaller 410 than Tdmax, then the ongoing phase begins and a Start indication is sent 414 to MCM 260 (FIG. 2). The path with the Tds is defined as the Current Path. The sequence counter (Scnt), the Block size counter (BScnt), and the CRC engines are reset. A CRC engine can sum the bits along a block. Scnt can be a modulo counter, the Scnt can be reset only in the Initialization Phase. The BScnt is reset for each block. A First-Path IMTP control segment is created and sent by TIMTPM 220 to the selected current path.

If it happens that one of the low-speed communication paths has a problem, its monitored Td value will be higher than Tdmax, as long as the problem exists. Such a low-speed path will be passed over while the problem persists but, may share the load when the problem is resolved or alleviated.

Next method 400 may run in a loop between step 416 and 420. At step 416 the high-speed bits in the input of the TIMTPM 220 are arranged into IMTP data segments. Appropriate headers and sequential numbers are added to each segment, and the values of Scnt and BScnt are incremented accordingly. Additionally, the CRC value is calculated and updated. These IMTP data segments are transferred to the FIFO and Monitoring module 240 in the current path. Then a decision is made 420 as to whether Td of the current path (Tdcurrent) is smaller than Tdmax. If the Tdcurrent is smaller, then method 400 returns to step 416. If Tdcurrent is longer than Tdmax, then method 400 proceeds to step 422 for terminating the first block of IMPT data segments. The block size and the CRC are calculated and a block size and a CRC IMTP control segments are created and sent 422 to the FIFO and Monitoring module 240 of the current path (the first path). Method 400 proceeds to step 424 in FIG. 4B.

In step 424 in FIG. 4B the Td of the paths other than the current path are calculated and the path with the smallest Td (Tds) is selected as the next path. If 430 the new Tds value is bigger than Jmax then method 400 proceeds to step 432. A dropping duration (Dd) begins 432, during the Dd high-speed physical layer bits are dropped and an error is sent to MCM 260 (FIG. 2). The Dd value can be a few milliseconds. At the end of the Dd, method 400 returns to step 424. If 430 the new Tds value is smaller than Jmax, then the Next-path IMTP control segment is created and sent through the current path 434 indicating which path will be the next path the IMTP segments will be sent through. Next-path IMTP control segment terminates the Block.

In case that one of the low-speed communication paths has a problem, thus its monitored Td value will be higher than Tdmax, as long as the problem exists. Such a low-speed path will be passed over during the existing of the problem and may share the load when the problem disappears.

At step 436 the current path is defined as the “Previous Path”, and the selected next path is defined as the “Current-Path”. The BScnt and the CRC engine are reset. A “Previous-Path” IMTP control segment is created and sent through the current path. Next an internal loop may be initiated between step 438 and 440. In step 438 the high-speed bits in the input of the TIMTPM 220 are arranged into IMTP data segments. Appropriate data headers and sequential numbers are added to each segment, and the values of Scnt and BScnt are incremented accordingly. In addition, the CRC value is calculated and updated. These IMTP data segments are transferred to the FIFO and Monitoring module 240 of the Current-Path. Then a decision is made 440 as to whether the Td of the Current-Path (Tdcurrent) is smaller than Tdmax. If the Tdcurrent is smaller, then method 400 returns to step 438. If 440 the Tdcurrent is longer than the Tdmax, then method 400 proceeds to step 442 thus terminating the current block.

An IMTP “Block-Size” control segment is created 442 and sent through the Current Path. The CRC is calculated and sent as an IMTP control segment through the Current Path and Method 400 returns to step 424.

FIG. 5A and FIG. 5B are flowchart diagrams illustrating relevant steps of a Receiver Multiplexing Transport Protocol (RMTP) process 500a. Method 500a can be executed by a Receiver Multiplexing Transport protocol Module (RMTPM) 320 (FIG. 3). Method 500a can be used for rearranging the new transport layer IMTP segments received at the input of (RMTPM) 320 via (LSIIM) 310a-c (FIG. 3) to a sequential stream of data bits of the physical layer of the high-speed communication link 112b (FIG. 3).

Method 500a can be initiated 502 during power on. After initiation in process 504 all the resources associated to RMM 300 can be reset. Resources can be such as but not limited to: Sequence counter (Scnt), Jitter Buffer (JB) (explained in more detail in conjunction with FIG. 5B), Receiver timer (Tr), FIFOs 330 of (FIG. 3), etc. Method 500a waits 506 for an Initiation Command sent from (MCM) 260 (FIG. 2) to RMCM 360 (FIG. 3). The Initiation Command can be sent through links other than the low-speed communication links. Once the Initiation Command is received, method 500a proceeds to step 508, resetting and starting timer Tr. The Tr value is compared to Initiation Delay (Di) value 510. The initiation delay Di value depends on the type of the low-speed communication link. The Di value can be a few seconds if the communication link is a satellite communication, and can be a few milliseconds for “Metro-Internet” communication, for example.

If 510 the Tr value is bigger than the Di value then there is probably a problem in the low-speed communication link, therefore a “Connection-Error” can be sent 512 to RMCM 360 and process 500a ends. If 510 the Tr value is smaller than the Di value, then method 500a checks if 514 any IMTP segments have been received. If 514 no IMTP segments have been received, then method 500a returns to step 510. If an IMTP segment has been received, then method 500a proceeds to step 520. In step 520, the received segment is parsed and examined whether it is an Initialization IMTP segment or not.

If 520 the received segment is not an Initialization IMTP segment, the Tr value is compared 522 to the Di value. If 522 the Tr value is smaller than the Di value, method 500a returns to step 520. If 522 the Tr value is bigger than the Di value, method 500a sends a “No-Initialization-Segment” error 524 to the RMCM 360 process 500a ends.

Returning now to step 520, if the received segment is an Initialization IMTP segment, then the Tr is stopped and the Jitter buffer (JB) is reset 526. Next method 500a waits for an IMTP segment 530. Upon receiving an IMTP segment, method 500a inspects whether 532 it is a “First-Path” or a “Previous-Path” IMTP segment. If the IMTP segment is neither, then the segment is loaded into the JB (Jitter Buffer) in memory-address number corresponding or related to the segment's sequence number 536 and method 500a returns to step 530. Each memory-location in the JB has a “Read-Me” indication bit. The Read-Me indication bit indicates that data in the cell can be loaded into FIFO 330 (FIG. 3). Once a segment is written (loaded) into one of the JB's memory-locations, the Read-Me indication bit is set ‘true’. When the data is loaded into the FIFO 330 the “Read-Me” indication is set ‘false’. If 532 the received IMTP segment is a “First-Path” or a “Previous-Path” IMTP segment, a reading process from the JB by the FIFO can be started 534. The reading process runs in parallel to method 500a and is disclosed below in conjunction with the description of FIG. 5B. After starting the JB reading process the IMTP segment is loaded 536 to the JB and method 500a returns to step 530.

FIG. 5B is a flowchart illustrating relevant processes used by a Jitter Buffer Draining method 500b. Method 500b can be executed by a Jitter Buffer (JB). The JB can be a component in RMTPM 320 (FIG. 3). Method 500b runs in parallel to steps 530, 532, and 536 of method 500a. This process begins for every block of segments, and runs from the beginning of the block until the end of the block. At step 552 the Receiver block size counter (RBScnt), the CRC engine and the timer Tr are reset. The Reading Address counter (RAcnt) is set to be the same as the sequence number of the “Previous-Path” or “First-Path” IMTP control segment, which is received over the new current low-speed path.

At step 554 the “Read-Me” indication bit of the JB memory at the address that is equal to the value of RAcnt is parsed. The state of the “Read-Me” indication is examined 560 to determine whether it is true or false. If the “Read-Me” indication is false 560, then the Tr value is compared 562 to the Jitter delay (Dj). If the Tr value is smaller than the Dj, then method 550b returns to step 560. If 562 the Tr value is larger than the Dj, then a “Missing Segment” indication is sent 564 to the RMCM 360 (FIG. 3) and method 500b ends 590. In another embodiment, not illustrated in the figures, instead of terminating at this point, method 500b may proceed to step 588, reset the Tr, increment the RAcnt and return to step 554 for handing the next address in the JB.

Returning now to step 560, if the Read-Me indication is true, then the data stored is fetched from the JB 566. Next, the method 550b examines whether the stored data is an IMTP data segment 570. If the stored data is an IMTP data segment, then the CRC of the current received block is calculated and updated; the IMTP data segment is stored in FIFO 330; and the RAcnt and RBScnt are incremented by one 572 and Tr is reset. The “Read-Me” indication bit is then converted to false. Next method 500b returns to step 554.

If 570 the data in relevant address (RAcnt) JB is not an IMTP data segment, then the IMTP segment is fetched and parsed 574 in order to determine its type. In step 576 the segment type is determined. Three possible types of non-data segments include: Next-Path, Block-Size or CRC. If the IMTP segment type is Next-Path, then it is stored 578 in FIFO 330 and method 500b ends 590. If the IMTP segment type is Block-Size, then the payload of the segment (the block size) is compared to the RBScnt value 580. If the block size is equal to RBScnt value, then method 500b returns to step 554. If block size is not equal to RBScnt value then a “Block-Size Error” indication is sent 582 to RMCM 360 (FIG. 3). Method 500b may then proceed to step 588 where it then operates to reset the Tr, increment the RAcnt and return to step 554 for handing the next address in the JB before method 500b returns to step 554.

If the segment type is CRC, then its payload (CRC value) is compared to the calculated CRC 584. If they are equal, then method 500b returns to step 554. If they are not equal, a “CRC-Error” is sent 586 to (RMCM) 360 (FIG. 3) and to (MCM) 260 (FIG. 2). Method 500b may then proceed to step 588 where it operates to reset the Tr, increment the RAcnt and return to step 554 for handing the next address in the JB method 500b returns to step 554.

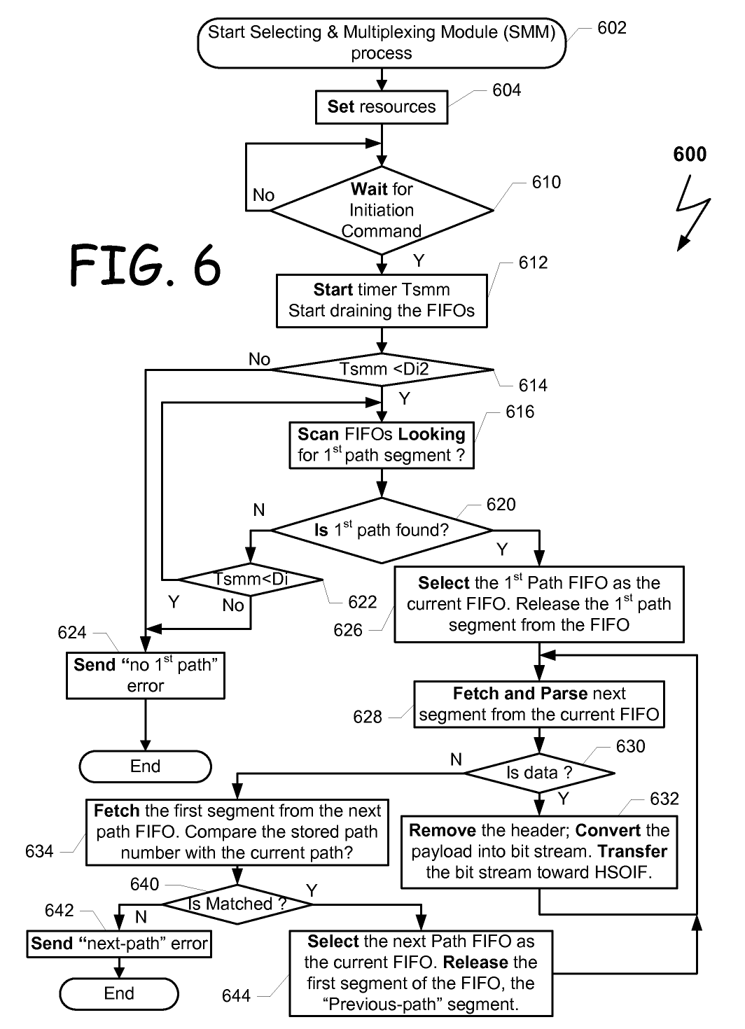

FIG. 6 is a flow diagram\chart illustrating relevant processes of an exemplary method 600 for multiplexing data into a single stream of bits to be transmitted over a high-speed link. Method 600 can be executed by an exemplary Selecting and Multiplexing Module (SMM) 340 (FIG. 3). Method 600 can be used to multiplex the IMTP segments from the different FIFOs 330 (FIG. 3) into one sequential stream of bits which are sent as data of the Physical Layer of the high-speed communication link by HSOIF 350 (FIG. 3) for example. Method 600 can begin 602 upon power on of the RMM 300 (FIG. 3). Resources associated with the SMM 340 such as, but not limited to, a Sequence counter and a timer Tsmm, are set 604. Method 600 waits for an Initiation Command 610 from the MCM 260 (FIG. 2) to the RMCM 360 (FIG. 3). Once an Initiation Command has been received 610, the SMM timer (Tsmm) is reset and then started 612. In parallel, each FIFO is drained at the rate of the high-speed communication link 112b (FIG. 3).

The Tsmm value is compared 614 to the value of a configurable Initiation Duration (Di2) parameter. If 614 Tsmm value is smaller than Di2 then all the FIFOs output are scanned 616 looking for a “First-Path” segment. Each segment is examined to determine if 620 it is the “First-Path” segment. If no First-Path segments are found, then the Tsmm is compared 622 to the Di. Initiation delay Di value is a configurable parameter. The Di depends on the type of the low-speed communication links. If the Tsmm value is smaller than the Di value, then method 600 returns to step 616. If the Tsmm value is bigger than the Di value, then method 600 sends 624 No-First-Path error indication to (RMCM) 360 and method 600 ends. If a First-Path segment is found at step 620, then the FIFO 330 that stores the First Path segment is defined as the Current FIFO 626, and the First-Path segment is released. Next SMM 340 starts fetching and parsing 628 the segments from the current FIFO.

Each IMTP segment is examined. If 630 the segment is identified as a data segment, then its header is removed and the payload of the data segment is stripped into bits. The bits are then transferred 632 as a bit stream at a high-speed rate toward the HSOIF 350 illustrated in FIG. 3. Next, method 600 returns to step 628 for handling the next IMTP segment in the Current-FIFO. If at step 630 the segment is not a data segment, meaning it is a “Next-path” control segment, the “Next-path” segment is fetched and parsed 634. The segment from the next-path FIFO is fetched. This segment is “Previous-path” control segment. Its payload is parsed and compared to the current path 640. If they are not the same, then a “Next-Path” Error indication is sent 642 to (RMCM) 360 and method 600 ends. If at step 640 they do match, then method 600 selects the next path FIFO as the current FIFO, releases the first segment in the FIFO, which is the “Previous-path” segment, and returns to step 628.

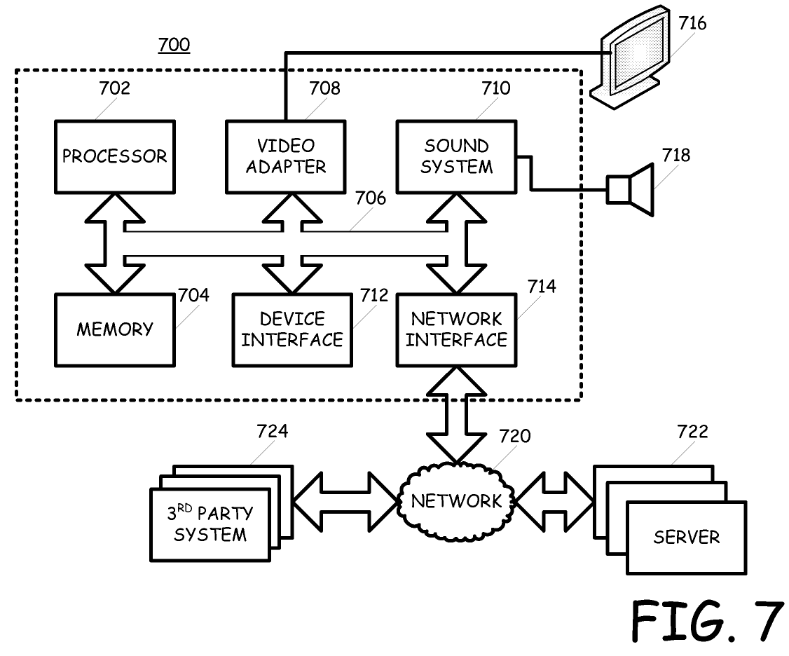

FIG. 7 is a general block diagram illustrating a hardware/system environment suitable for various embodiments of the present invention or various components of the embodiments of the invention. A general computing platform 700 is shown as including a processor 702 that interfaces with a memory device 704 over a bus or similar interface 706. The processor 702 can be a variety of processor types including microprocessors, micro-controllers, programmable arrays, custom IC's etc. and may also include single or multiple processors with or without accelerators or the like. The memory element 704 may include a variety of structures, including but not limited to RAM, ROM, magnetic media, optical media, bubble memory, FLASH memory, EPROM, EEPROM, etc. The processor 702 may also interface to a variety of elements including a video adapter 708, sound system 710, device interface 712 and network interface 714. The video adapter 708 my be used to drive a display, monitor or dumb terminal 716. The sound system 710 interfaces to and drives a speaker or speaker system 718. The device interface 712 may interface to a variety of devices (not shown) such as a keyboard, a mouse, a pin pad, and audio activate device, a PS3 or other game controller, as well as a variety of the many other available input and output devices. The network interface 714 is used to interface the computing platform 700 to other devices through a network 720. The network may be a local network, a wide area network, a global network such as the Internet, or any of a variety of other configurations including hybrids, etc. The network interface may be a wired interface or a wireless interface. The computing platform 700 is shown as optionally interfacing to a server 722 and a third party system 724 through the network 720. The illustrated system or similar systems may serve as one or more component of the various embodiments. The network interface 714 may actually include a plurality of interfaces including interfaces to the high-speed communication link and/or the plurality of low-speed communication links.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware. Software of a logical module can be embodied on a computer readable medium such as a read/write hard disc, CDROM, Flash memory, ROM, etc. In order to execute a certain task a software program can be loaded to an appropriate processor as needed.

Various aspects, features and embodiments of the present invention have been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

What is claimed is:

1. A system that enables high-speed media communication between a first node and a second node over a plurality of low-speed communication links, the system comprising:
a transmitting inverse multiplexer; and
a receiving multiplexer;
wherein said transmitting inverse multiplexer receives from the first node over a first high-speed communication line, a stream of groups of one or more bits, arranges said stream of groups of one or more bits into inverse multiplexing transport protocol segments, and transmits said inverse multiplexing transport protocol segments towards the second node over the plurality of said low-speed communication links, and
wherein the transmitting inverse multiplexer determines when to switch from a first low-speed communication link to a second low-speed communication link from the plurality of low-speed communication links based at least in part on a current delay indication over the first low-speed communication link; and
wherein the receiving multiplexer receives said inverse multiplexing transport protocol segments from said one or more of the plurality of low-speed communication links; multiplexes the received inverse multiplexing transport protocol segments; and converts the segments into a stream of groups of one or more bits, which are arranged in a similar order to the order of the stream of groups of one or more bits received from the first high-speed communication line, to be transmitted toward the second node over a second high-speed data communication line.

2. The system of claim 1, wherein the transmitting inverse multiplexer further selects the second low-speed communication link from the plurality of low-speed communication links and switches to said second low-speed communication link based at least in part on jitter threshold.

3. The system of claim 1, wherein at least one of the plurality of low-speed communication links employs a different communication layer protocol than what is employed by one or more other of the plurality of low-speed communication links from the plurality of low-speed communication links at an equivalent communication layer.

4. The system of claim 3, wherein the communication layer is selected from a group of communication layers consisting of physical layer, data link layer and network layer.

5. The system of claim 1, wherein the transmitting inverse multiplexer further transmits a block of variable number of consecutive inverse multiplexing transport protocol segments over a currently selected low-speed communication link out of said plurality of low-speed communication links, wherein the variable number depends on the current delay indication over the currently selected low-speed communication link.

6. The system of claim 1, wherein the transmitting inverse multiplexer further selects the second low-speed communication link from the plurality of low-speed communication links based on the jitter threshold and a current delay indication over the second low-speed communication link.

7. The system of claim 1, wherein the transmitting inverse multiplexer further selects a next low-speed communication link out of said plurality of low-speed communication links based on predefined criteria.

8. The system of claim 1, wherein the communication over the first high-speed communication line is based on the open system interconnection model and the stream of groups of one or more bits received by said transmitting inverse multiplexer is a stream of bits that complies with a physical layer protocol of the first high-speed communication line.

9. The system of claim 1, wherein the communication over the second high-speed communication line is based on the open system interconnection model and the stream of groups of one or more bits transmitted by said receiving multiplexing module is a stream of bits that complies with a physical layer protocol of the second high-speed communication line.

10. The system of claim 1, wherein the transmitting inverse multiplexer is embedded within the first node.

11. The system of claim 1, wherein the receiving multiplexer is embedded within the second node.

12. The system of claim 1, further comprising an inverse multiplexing transport protocol which defines the flow control between the first node and the second node over the plurality of low speed communication links by defining flow information that is associated with each block of inverse multiplexing transport protocol segments that is currently transmitted over one of the plurality of low speed communication links.

13. An apparatus that inverse multiplexes and transmits a stream of groups of one or more bits of a high-speed data communication link over a plurality of low-speed data communication links; the apparatus comprising:
a. a transmitter inverse multiplexer;
b. a plurality of low-speed output interfaces with each one being associated with one of said plurality of low-speed data communication links; and
c. a plurality of monitors each monitor being associated with a low-speed communication link and monitors a current load indication over the associated low-speed communication link;
wherein the transmitter inverse multiplexer receives a stream of groups of one or more bits at the high-speed data communication rate, arranges said stream of groups of one or more bits into inverse multiplexing transport protocol segments, and transmits said inverse multiplexing transport protocol segments toward the plurality of said low-speed output interfaces, wherein the transmitter inverse multiplexer further determines when to switch from a first low-speed communication link to a second low-speed communication link from the plurality of low-speed communication links depending at least in part on the current load indication received from the monitor that is associated with the first low-speed communication link; and
wherein each of said low-speed output interfaces process said inverse multiplexing transport protocol segments to comply with the requirements of the associated low-speed data communication link.

14. The apparatus of claim 13, further comprising a high-speed interface that processes the high-speed data communication received over the high-speed data communication link and delivers a stream of groups of one or more bits toward said transmitter inverse multiplexer.

15. The apparatus of claim 13, wherein the transmitter inverse multiplexer further determines when to switch from the first low-speed communication link to the second low-speed communication link from the plurality of low-speed communication links based on a predefined jitter threshold.

16. The apparatus of claim 13, wherein at least one particular communication layer used over one or more low-speed communication links of the plurality of low-speed communication links differs from an equivalent communication layer used over at least one other low-speed communication link of the plurality of low-speed communication links.

17. The apparatus of claim 16, wherein the at least one particular communication layer is selected from a group of communication layers consisting of the physical layer, data link layer and network layer.

18. The apparatus of claim 13, wherein the transmitter inverse multiplexer further operates to select the second low-speed communication link from the plurality of low-speed communication links based on a jitter parameter and a current load indication received from the monitor that is associated with the second low-speed communication link.

19. The apparatus of claim 13, further comprising an inverse multiplexing transport protocol which defines the flow control between the first node and the second node over the plurality of low speed communication links by defining flow information that is associated with each block of inverse multiplexing transport protocol segments that is currently transmitted over one of the plurality of low speed communication links.

20. An apparatus that is configured to multiplex protocol segments received from a plurality of low-speed data communication links into a stream of groups of one or more bits at a high-speed data communication rate; the apparatus comprising:
a. a plurality of low-speed input interfaces, each being associated with one of said plurality of low-speed data communication links;
b. a plurality of receiver multiplexers each one is associated with one of said plurality of low-speed input interfaces; and
c. a selector and multiplexer;
wherein each one of said plurality of low-speed input interfaces is configured to receive low-speed data communication over its associated low-speed communication link; convert the received low-speed data into inverse multiplexing transport protocol segments, and transfer the segments toward its associated receiver multiplexer;
wherein each receiver multiplexer is configured to rearrange the received segments in a sequential order using a jitter buffer; and transfer the rearranged segments toward said selector and multiplexer; and
wherein said selecting and multiplexing module multiplexes the rearrange segments received from said plurality of receiver multiplexers into a consecutive stream of groups of one or more bits at the high-speed data communication rate.

21. The apparatus of claim 20, further comprising an inverse multiplexing transport protocol which defines the flow control between the first node and the second node over the plurality of low speed communication links by defining flow information that is associated with each block of inverse multiplexing transport protocol segments that is currently transmitted over one of the plurality of low speed communication links.

22. A method for inverse multiplexing a high-speed data stream into a plurality of low-speed data streams, the method comprising:
receiving a stream of groups of one or more bits at a high-speed data communication rate;
dividing the stream of groups of one or more bits into a plurality of inverse multiplexing transport protocol (IMTP) data segments, wherein each IMTP segment is associated with a header and a payload of one or more bytes from the received high-speed bit stream of groups of one or more bits;
transferring a block of IMTP data segments toward a first low-speed communication path; and
determining when to switch to a second low-speed communication path when a current calculated delay, which a next IMTP data segment will face if being transferred over the first low-speed communication path, is larger than a predefined latency threshold.

23. The method of claim 20, wherein determining when to switch from the first low-speed communication path to the second low-speed communication path further depends on a predefined jitter threshold.

24. The method of claim 21, wherein the second low-speed communication path is selected from the plurality of low-speed communication paths based on the predefined jitter threshold and a calculated current delay indication over the second low-speed communication path.

25. The method of claim 21, wherein the step of transferring a block of IMTP data segments toward a first low-speed communication path further comprises defining the flow control between a first node and a second node over the plurality of low speed communication links further comprises utilizing an inverse multiplexing transport protocol which defines flow information that is associated with each block of inverse multiplexing transport protocol segments that is currently transmitted over one of the plurality of low speed communication links.

26. A method for transferring high-speed data communication between a first node and a second node over a plurality of low-speed data communication links; the method comprising the steps of:
a. commencing to transmit portions of the high-speed data communication received from the first node to the second node over at least one of the plurality of low-speed data communication links;
b. monitoring at least one current load parameter of each of said plurality of low-speed data communication links;
c. selecting, based on the monitored current load parameter, a next low-speed data communication link; and
d. commencing to transmit a next portion of the high-speed data communication between the first and the second nodes over the next low-speed data communication link.

27. The method of claim 26, wherein the load parameter is monitored by determining a current latency over the low-speed data communication link.

28. The method of claim 26, wherein the step of selecting of the next low-speed data communication link further selecting a low-speed communication link based on a predefined criteria.

29. The method of claim 26, wherein the steps of transmitting portions of the high-speed communication between the first node and the second node over the plurality of low speed communication links further comprises utilizing an inverse multiplexing transport protocol which defines flow information that is associated with each block of inverse multiplexing transport protocol segments that is currently transmitted over one of the plurality of low speed communication links.

30. A system that carries high-speed media communication between a first node and a second node; the system comprising:
a. a first high-speed communication link that is capable of carrying high-speed media communication;
b. a second high-speed communication link that is capable of carrying high-speed media communication;
c. a plurality of low-speed communication links, wherein at least one communication layer used over one or more low-speed communication links from the plurality of low-speed communication links differs from an equivalent communication layer used over another low-speed communication link of the plurality of low-speed communication links;
d. a transmitting-inverse-multiplexer communicatively coupled to the first node via the first high-speed communication link; and
e. a receiving-multiplexer communicatively coupled to the transmitting-inverse-multiplexer via the plurality of low-speed communication links and to the second node via the second high-speed communication link;
wherein the transmitting-inverse-multiplexer receives from the first node a stream of groups of one or more bits at the high-speed data communication rate, arranges said stream of groups of one or more bits into inverse multiplexing transport protocol segments, and transmits said inverse multiplexing transport protocol segments over the plurality of said low-speed communication links toward the receiving-multiplexer; and
wherein the receiving-multiplexer receives said inverse multiplexing transport protocol segments from said plurality of low-speed communication links; multiplexes the received inverse multiplexing transport protocol segments; and converts the segments into a stream of groups of one or more bits, which are arranged in a similar order to the order of the stream of groups of one or more bits received from the first high-speed communication line, to be transmitted toward the second node at the high-speed data communication rate.

31. The system of claim 30, wherein the at least one communication layer is selected from a group of communication layers consisting of physical layer, data link layer and network layer.

32. The system of claim 30, wherein the communication is based on the open system interconnection model, the stream of groups of one or more bits received by said transmitting inverse multiplexer is a stream of bits that complies with a physical layer protocol of the high-speed communication.

33. The system of claim 30, wherein the transmitting-inverse-multiplexer further determines when to switch from a first low-speed communication link to a second low-speed communication link from the plurality of low-speed communication links depends on a current load indication over the first low-speed communication link.

34. The system of claim 30, further comprising an inverse multiplexing transport protocol which defines the flow control between the first node and the second node over the plurality of low speed communication links by defining flow information that is associated with each block of inverse multiplexing transport protocol segments that is currently transmitted over one of the plurality of low speed communication links.

35. The inverse multiplexing transport protocol of claim 34, wherein the flow information comprises at least one parameter selected from a group of parameters consisting of: the amount of inverse multiplexing transport protocol segments that were sent in the current block of inverse multiplexing transport protocol segments, an indication on a low speed communication link that carried the preceding block of inverse multiplexing transport protocol segments and an indication on a low speed communication link that will carry the subsequent block of inverse multiplexing transport protocol segments.
